(19) United States
(12) Patent Application Publication
(10) Pub. No.: US 2014/0327415 A1
(43) Pub. Date: Nov. 6, 2014

(54) PHASE BALANCING OF HIGH-FREQUENCY POWER GENERATION UNITS

(71) Applicant: TRUMPF Huettinger GmbH + Co. KG, Freiburg (DE)

(72) Inventors: Michael Hoch, Waldkirch (DE); Armin Bannwarth, Waldkirch (DE); Cemalettin Aykan, Freiburg (DE)

(21) Appl. No.: 14/333,702

(22) Filed: Jul. 17, 2014

Related U.S. Application Data
(63) Continuation of application No. PCT/EP2013/050770, filed on Jan. 17, 2013.

(30) Foreign Application Priority Data
Jan. 19, 2012 (DE) 102012200702.4

(51) Int. Cl. H02M 5/04

(52) U.S. Cl. CPC H02M 5/04
USPC 323/237

(57) ABSTRACT

Methods, systems, and devices for phase balancing of a plurality of high frequency (HF) power generation units of an HF power supply system. In one aspect, a method includes measuring a first signal related to a first power reflected at a load and arriving at a first HF power generation unit, obtaining at least one first value related to the measured first signal in a system control, adjusting at least one of a frequency or a phase of an output signal of the first HF power generation unit based on the at least one first value and a reference value, measuring a second signal related to a second power reflected at the load and arriving at the first HF power generation unit, obtaining at least one second value related to the measured second signal in the system control, and determining whether a specified event for the first HF power generation unit occurs. The method also includes performing phase balancing of one or more further HF power generation units.

### CROSS REFERENCE TO RELATED APPLICATIONS

This application is a continuation of and claims priority under 35 U.S.C. §120 to PCT Application No. PCT/EP2013/050770 filed on Jan. 17, 2013, which claimed priority under 35 U.S.C. §119 to German Application No. DE 10 2012 200 702.4 filed on Jan. 19, 2012. The content of these priority applications are hereby incorporated by reference in their entirety.

### TECHNICAL FIELD

This specification relates to methods, systems, and devices for phase balancing of a plurality of high-frequency (HF) power generation units of an HF power supply system.

### BACKGROUND

High-frequency power supply systems (HF power supply systems), that is to say systems that generate power at frequencies greater than 1 MHz, are used, for example, for laser excitation, in plasma coating installations or for induction applications. In such high-frequency power supply systems, a plurality of HF power supply units are frequently used in order to generate a total power of the HF power supply system therefrom. The output signals of the high-frequency power supply units are generally not phase-synchronous. However, these output powers frequently have to be combined into one power, for example by means of combiners or directly at a load, for example a plasma electrode or a gas laser electrode. Fixed phase relationships of the starting powers are required in order to combine the HF power generation units. A possibility must therefore be provided of influencing the phases of the output signals of the HF power generation units relative to one another.

In order to keep process downtimes as short as possible, or in order to avoid them, it is to be possible to be able to replace HF power generation units with similar HF power generation units quickly and uncomplicatedly. Corresponding combiners are also to be replaceable. In the case of changes to the load, for example in the case of changes to the gas pressure in gas laser excitation installations or in plasma processing installations, the HF power generation units are to continue to work stably and with maximum efficiency. However, after the replacement of individual power generation units or combiners, a changed phase relationship may be present, for example, owing to component tolerances, and it may thus be necessary to readjust the phase relationship between the individual HF power generation units. It would be disadvantageous if this had to be readjusted manually or if additional measuring units for detecting further measurements were required.

### SUMMARY

One aspect of the invention features a method for phase balancing of a plurality of HF power generation units of an HF power supply system. The method can include the following method steps:

a. measuring a signal that is related to a power reflected at a load and arriving at a first HF power generation unit,

b. transmitting at least one value that is related to the measured signal to a system control, or transmitting the measured signal to a system control and calculating in the system control a value that is related to the measured signal,

c. determining a reference value for the value of the first HF power generation unit in the system control, or providing a reference value for the value of the first HF power generation unit to the system control,

d. changing the frequency and/or the phase of the output signal of the first HF power generation unit,

e. again measuring a signal that is related to the power reflected at a load and arriving at the first HF power generation unit,

f. transmitting to the system control a value that is related to the signal measured in step e., or transmitting the signal measured in step e. to the system control and calculating in the system control a value that is related to the signal measured in step e., and

g. repeating steps c. to f. or d. to f. until a specified event occurs.

The method can also include step h.: steps a.-g. are carried out for one or more further power generation units.

Method steps a.-h. are preferably carried out, e.g., immediately, after the HF power supply system has been switched on or restarted. The specified event is preferably an event which is related to a desired phase balancing or indicates the desired phase balancing. For example, it can be an event which occurs when one or more HF power generation units or the HF power supply system are working at a predetermined efficiency.

In some examples, the event can indicate that the powers reflected by the load and arriving at each of the HF power generation units are in a predetermined relationship with one another, which can be or is recognized by the system control as a predetermined relationship that leads, for example, to the predetermined efficiency. It is not absolutely necessary for the reflected power in the HF power generation units to be adjusted to a minimal value. Nor is that desirable in all operating states. The predetermined relationship of the reflected powers with one another is merely to be so adjusted that the specified event occurs which, for example, indicates a predetermined efficiency. The monitored relationship between the powers arriving at the HF power generation units can be one or more of the parameters phase, amplitude, reflection factor.

In some examples, the event can indicate that the powers reflected by the load and arriving at each of the HF power generation units differ from one another by less than a predetermined value. In that manner, good symmetry in the HF power supply system and sufficiently uniform loading of all the HF power generation units can be achieved.

In some implementations, the HF power supply system can adjust the phase relationship of the individual HF power generation units with one another automatically during operation. It is possible to replace individual HF power generation units and then put the system into operation again without manually having to carry out a balancing of the phase position. Preferably, each HF power generation unit is fully functional independently on its own. This means that each HF power generation unit has its own measuring system for determining the power supplied and fed back and in particular also its own regulating system for regulating to those measurements. The possibility of replacing the individual components of the HF power supply system is thereby simplified.

Additional measuring devices for determining the phase position or phase relationship between the output signals of the HF power generation units are not required. The HF power supply system can be of modular construction. In some cases, it is possible to adjust the phase on the basis of information which comes from a signal, namely the reflected power, which does not itself have a phase component. A frequency signal and a phase-adjusting signal can be provided to the individual power generation units by the system control.

A signal which is related to the reflected power is in particular also a signal which describes the reflection factor, the possibly complex impedance of the load or the voltage standing-wave ratio (VSWR). If a plurality of amplifiers are operated within a power generation unit, for example phase-shifted by 90°, and if the output power of the amplifiers is combined by means of a combiner to form an output power of the power generation unit, then it is possible, by comparing the current consumption of the amplifiers, to generate a signal which is related to the reflected power. This is described in EP 2 202 776 A1, for example.

The term “phase position” means the phase relationship of the output signals of the power generation units with one another. It can best be imagined when it is assumed that all the power generation units acquire the same high-frequency excitation signal transmitted with the same phase. On account of different propagation delays at their outputs, the individual power generation units may exhibit signals which do not have the same phase. This is often undesired, however. Alternatively, it could be desired that the phase of the output signals of the power generation units is not the same. By purposively changing the phase of the output signals of individual power supply units, that is to say of a phase relationship with a reference phase known to all the power generation units, the phase of the output signals at the output of all the power generation units can be adjusted to a predetermined degree. This means that the phase difference between the output signals of the individual power generation units can be adjusted.

When the HF power supply system is switched on, the system control can in particular check whether at least one power generation unit or at least one combiner of the HF power supply system has been replaced or added, and the method steps a. to h. can be carried out only in the case where such a replacement or such an addition has been detected.

One of the following can be chosen as the specified event:

a. the value calculated in step f. differs from the reference value by less than a specified amount,

b. the value calculated in step f. has exceeded or fallen short of the reference value,

c. the value calculated in step f. changes in a specified direction,

d. a difference between the value calculated in step f. and the reference value falls short of a specified difference value after repetition of the steps mentioned in step g.,

e. a specified number of repetitions according to step g. has been carried out, or

f. a mathematical combination of a plurality of values determined in step f.
i. differs from a specified reference value by less than a specified amount,
ii. has exceeded or fallen short of a specified reference value, or
iii. has changed in a specified direction.

In a variant of the aspect, it can be provided that the mean of the values calculated in steps b. and f. is determined as the reference value. For example, the mean of the reflected powers can be calculated. The system control can then try to balance the first power supply unit to that value or to balance all the power supply units until an optimal reflected power is established overall. The mean can be newly calculated for each pass or it can be stored and balancing to the stored mean that can be carried out for each pass. Alternatively, it is conceivable to specify a fixed mean, in particular to specify a value for the reflected power that is as small as possible, and to adjust the frequency and phase of the output signals of the power generation units in such a manner that the specified value is achieved as closely as possible.

It is further conceivable for method steps c. to f. or d. to f. of the method to be carried out iteratively several times for individual or all of the power generation units.

Changing of the frequency and/or phase of the first or a further HF power generation unit can be carried out by providing a frequency signal and phase information to the power generation unit.

In some implementations, the adjustment of the phase of the output signal of a power generation unit takes place in the power generation unit itself. This means that a power generation unit preferably has a phase-adjusting device, for example a phase shifter.

The output powers of the power generation units can be combined by means of one or more combiners to a total power. The phase position of the power generation units can thereby depend on the nature of the combiner used for power combining. If, for example, a 90° hybrid combiner is used, the output signals of the power generation units which are to be combined by the combiner can have a phase shift of 90°.

When the output powers of the power generation units or of at least some power generation units are combined by one or more combiners to a total power which is supplied to a load, the power reflected at the load is passed from the load via the combiner or combiners back to the power generation units again. The reflected power is thereby split in the combiner or combiners. The measured signal at each power generation unit is thus only a part of the reflected power. The measured signal is, however, related to the power reflected by the load. It should also be mentioned here that it is not necessary to measure a power arriving directly at a power generation unit, for example by means of a directional coupler, but other electrical values, such as current or voltage, which are related to the arriving power can also be measured.

The power generation units are preferably operated with identical forward power, that is to say all the power generation units generate the same power at their outputs. A symmetrical system is accordingly advantageous. This facilitates phase adjustment based on signals which are related to the reflected power.

It is conceivable in principle to transmit the signals that are related to the reflected power to the system control and evaluate them therein. This may require additional evaluation devices in the system control, in particular when a plurality of power generation units are connected to the system control. Alternatively, therefore, it is conceivable to process or evaluate the signals for the respective power generation units that are related to the reflected power in the power generation units in order to determine a value for transmission to the system control.

The phase can be adjusted in each power generation unit by means of a dynamically programmable logic unit in the form of a phase-adjusting device or part of a phase-adjusting device. For example, a field programmable gate array (FPGA), an application specific integrated circuit (ASIC), a delay line or a complex programmable logic device (CPLD) can be used as the logic unit. The propagation delays of these logic units can be used for the phase adjustment. It is also possible to use digital clock monitors (DCM). A phase-adjusting device can be in the form of a phase-shifting unit or can comprise such a unit.

The adjustment options of phase-shifting units can be finite, particularly when a logic unit is used as the phase-shifting unit. If, for example, in a first power generation unit the phase cannot be adjusted further, that is to say a phase-shifting unit has reached its natural limit, but sufficient balancing has not yet been achieved, the phase can be changed in greater intervals in this power generation unit or in other power generation units. Such a greater interval can be, for example, 90° phase shift. All the methods described here can thereafter be applied further. The change in greater intervals can also take place from the phase-shifting unit of the corresponding power generation unit or in another control element. A suitable logic unit (e.g. FPGA, ASIC) can thereby generate a multiple of the frequency, for example four times the frequency, provided as the output power of the power generation unit, for example by means of a phase locked loop (PLL). This multiple of the frequency can be used with logic linkages for such a phase jump.

The system control can store the values for the frequency and/or phase established in method step d. of the method. Accordingly, these values are also available for later method steps.

When the power generation units are switched on, the system control can transmit pre-adjusted or stored values for the frequency and phase to the power generation units. As a result, start values can be specified by the system control, which can then be modified in the course of the method.

Another aspect of the invention features an HF power supply system having a system control and a plurality of HF power generation units. The HF power generation units are connected in terms of signalling to the system control, and at least two HF power generation units have measuring devices for detecting a signal that is related to the power reflected at a load and arriving at the power generation unit in question. The HF power supply system has at least one value-calculating unit for calculating values which are related to the signals detected by the measuring devices. The system control has a calculation device, connected to the HF power generation units, for calculating the phase and/or frequency to be adjusted of at least two HF power generation units in dependence on the values calculated in the at least one value-calculating unit. In such a system, no additional measuring devices for calculating the phase position between the outputs of the HF power generation units are required. The system can be highly modular in construction. In particular, individual components of the system can easily be replaced. The system can automatically correct and adjust the phase position between the outputs, or the signals outputted there, of the HF power supply units during operation. Alternatively, it is conceivable to initiate the method according to the invention, as discussed above, as a calibration run from outside, in particular manually. When the phases of the output signals have once been adjusted, they can be retained during operation and not constantly updated.

At least two HF power generation units can have a phase-adjusting device, which phase-adjusting devices are connected in terms of signalling to the system control. A phase-adjusting device is preferably provided in each HF power generation unit. The power generation units can then be replaced at any time. Such HF power generation units can be incorporated into many different systems with different system controls. Improved modularity is accordingly achieved.

The system control can have an evaluation device for evaluating the values related to the signals detected by the measuring means. The values of the evaluation device can be provided to the system control directly by the power generation units, that is to say the values are then calculated in the HF power generation units. Alternatively, the values can first be determined in the system control and given to the evaluation device there.

If the values are to be calculated in the power generation units, it is advantageous if at least one power generation unit has a value-calculating unit.

It is in principle conceivable to integrate the system control into one of the power generation units. However, the modularity of the system is limited slightly as a result. When the power generation unit with the system control is replaced, a new system control can also be provided. The replacement of individual power generation units is simpler when an external system control is provided, that is to say a system control that is provided externally to the power generation units.

In order to allow the output signals of the individual power generation units to be combined, it is advantageous if at least one combiner for combining the output power of at least two power generation units is provided. The phase of the output signals of the power generation units is thereby preferably so adjusted that approximately the same power is supplied by all the power generation units, that is to say the combined output power is distributed symmetrically over the power generation units. Whether and how well this has been achieved can be determined by measuring and evaluating the signals that are related to the reflected power.

Each power generation unit can have a phase-adjusting device. Such power generation units can be used with a high degree of modularity. They can be used not only in the described manner with the system control for phase adjustment, but also in other environments or applications in which phase shifting is required.

The phase-adjusting device can have a dynamically programmable logic unit, for example an FPGA, ASIC, a delay line or a CPLD. The method steps can as a result be carried out fully automatically during operation.

Each power generation unit can have a power-measuring device. This also assists with the modular usability of the power generation unit. Such a power generation unit can not only be used in the described manner with the system control for frequency and/or phase adjustment, but can also regulate its power itself The power-measuring device can be suitable for detecting the reflected power and/or the power generated in the power generation unit, that is to say it can serve as an above-mentioned measuring means.

A power generation unit can be composed of a plurality of amplifiers or inverters. The phase position of these amplifiers or inverters relative to one another can likewise be adjusted by means of the dynamically programmable logic units. The plurality of amplifiers or plurality of inverters can have a plurality of transistors, for example in the form of a push-pull amplifier or a half- or full-bridge class D arrangement. The phase position of the transistors can likewise be adjusted by means of the dynamically programmable logic units. Within a power generation unit, a dynamically programmable logic unit can perform all the adjustments.

Each power generation unit can have an input connection for a high-frequency excitation frequency signal. Such power generation units can be used with a high degree of modularity. They can be used not only in the described manner with the system control for frequency and/or phase adjustment, but also in other environments or applications in which frequency adjustment is required.

Other aspects of the invention feature a non-transitory computer readable storage medium storing instructions executable by one or more processors and upon such execution cause a high frequency (HF) power supply system to perform operations for phase balancing of a plurality of HF power generation units of the HF power supply system.

The operations include a plurality of steps: a. measuring a first signal that is related to a first power reflected at a load and arriving at a first HF power generation unit of the HF power supply system; b. obtaining at least one first value related to the measured first signal of the first HF power generation unit in a system control; c. adjusting at least one of a frequency or a phase of an output signal of the first HF power generation unit based on the at least one first value and a reference value; d. measuring a second signal that is related to a second power reflected at the load and arriving at the first HF power generation unit; e. obtaining at least one second value related to the measured second signal of the first HF power generation unit in the system control; and f. determining whether a specified event for the first HF power generation unit occurs. The operations also include performing the plurality of steps for one or more further HF power generation units of the HF power supply system.

Further features and advantages of the invention will become apparent from the following description of an exemplary embodiment of the invention, with reference to the figures of the drawing, which show details that are essential to the invention, and from the claims. The individual features can each be realised individually or several can be realised in an arbitrary combination in a variant of the invention.

### DESCRIPTION OF DRAWINGS

FIG. 1 shows a schematic diagram of an example HF power supply system.

FIG. 2 shows a flow diagram of an example process performed by the HF power supply system of FIG. 1.

In the following description of the drawing, identical reference numerals are used for components which are the same or have the same function.

### DETAILED DESCRIPTION

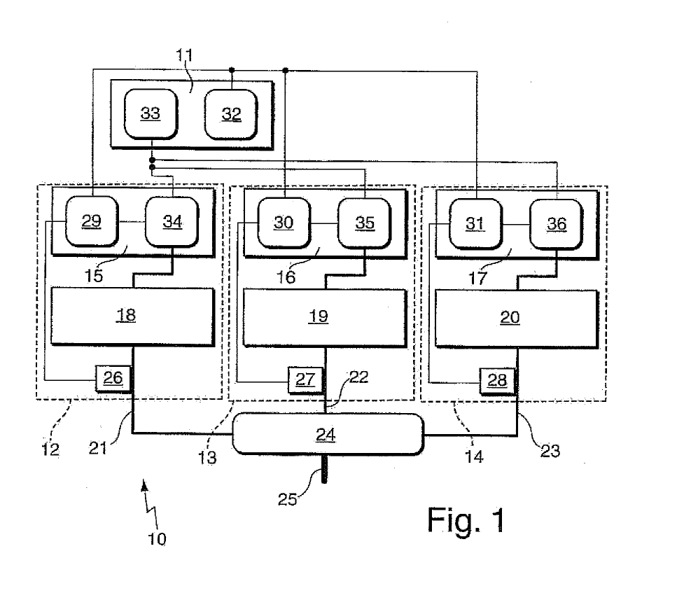

The HF power supply system 10 shown in FIG. 1 comprises a system control 11, to which three HF power generation units 12, 13, 14 are connected in the exemplary embodiment. The HF power generation units 12, 13, 14 each comprise a control module 15, 16, 17 and a power generation module 18, 19, 20. The outputs 21, 22, 23 of the power generation units 12, 13, 14 are guided to a combiner 24, where the output powers of the power generation units 12, 13, 14 are optionally combined phase-dependently. The combined total power is outputted at the output 25 and fed to a load, which is not shown here.

The power generation units 12, 13, 14 each have measuring devices 26, 27, 28, with which at least the power reflected by the load, which arrives at the power generation units 12, 13, 14, can be detected. The measuring devices 26, 27, 28 are preferably in the form of directional combiners, so that both a reflected and an output power of the respective power generation unit 12, 13, 14 can be detected. The measured signals that are related to the reflected power, which are detected by the measuring devices 26, 27, 28, are given to a value-calculating unit 29, 30, 31 in the control modules 15, 16, 17. In the value-calculating units 29, 30, 31, values are calculated which are then given to the system control 11, in particular to a calculating device 32.

The calculating device 32 calculates the phase position of the output signals of the power generation units 12, 13, 14 that is to be set. The phase position that is to be set is given by the calculating device 32 to the value-calculating units 29, 30, 31. The system control 11 is accordingly connected bidirectionally in terms of signalling to the power generation units 12, 13, 14.

The system control 11 further has a frequency-generating unit 33, by which a high-frequency excitation frequency signal is provided. The frequency-generating unit 33 is connected to phase-adjusting devices 34, 35, 36 of the power generation units 12, 13, 14. The phase-adjusting devices 34, 35, 36 can be in the form of phase shifters, in particular in the form of FPGAs. The phase-adjusting devices 34, 35, 36 shift the high-frequency signal provided by the frequency-generating unit 33 according to the phases or phase positions specified by the value-calculating units 29, 30, 31. A phase-controlled high-frequency signal is thus present at the output of the modules 15, 16, 17. This phase-controlled high-frequency signal is fed to the HF power modules 18, 19, 20, where the respective HF power output signals are generated.

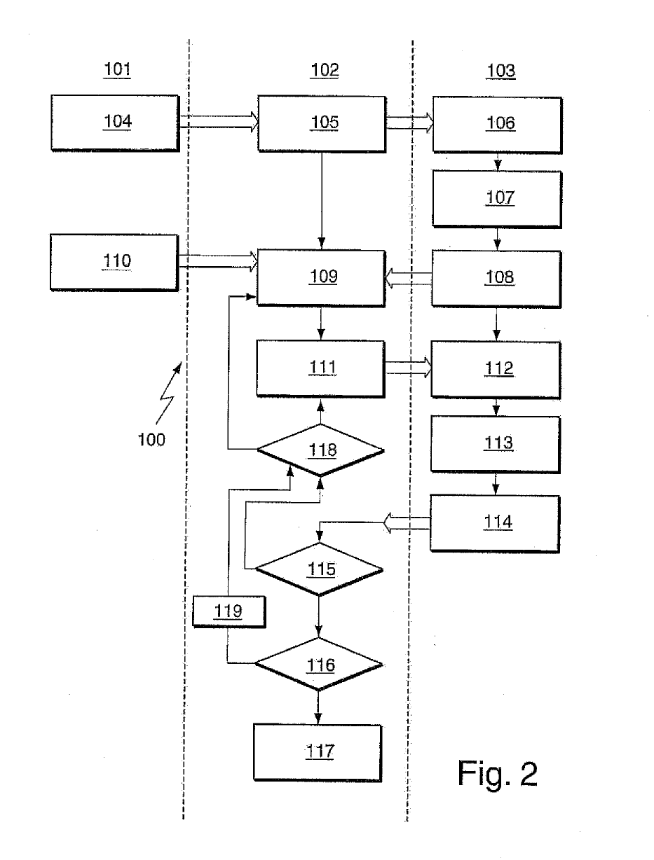

FIG. 2 shows a kind of flow diagram 100 for explaining the method according to the invention. Actions of an operator or external inputs are indicated in the left column 101. Actions which are carried out in the system control are indicated in column 102, and actions of the power generation units are indicated in column 103.

In step 104, a frequency and/or a phase position of the individual power generation units can be specified. In step 105, pre-adjusted or stored values for the frequency and/or phase are transmitted to all the power generation units. In accordance with those values, the power generation units are operated with the specified frequency and phase in step 106. A signal which is related to the power reflected by a load and arriving at a power generation unit is measured and optionally processed in step 107. In the processing of a signal, a value can be determined, for example. In step 108, the measured signal, or a value that is related to the measured signal, is transmitted to the system control. In the system control, a reference value can be determined or selected in step 109 on the basis of the transmitted values from step 108. A fixed reference value or a variable reference value for step 109 can be provided by step 110. Step 110 can also provide a calculation procedure for the reference value.

In dependence on the values and the reference value, the frequency and/or phase provided to the individual power generation units is changed in step 111. In step 112, the power generation units are operated with the changed values for frequency and/or phase.

In step 113, a signal that is related to the reflected power is again measured and optionally processed. In step 114, the signal, or a processed signal, or a value, is transmitted to the system control. In step 115, an inquiry is made as to whether a specified event for a particular power generation unit has occurred. If that is the case, the method passes to step 116 and it is checked whether the event has occurred for all the power generation units. If this question is also answered in the affirmative, the current values for frequency and/or phase or phase position are stored in step 117.

If the answer to the question in step 115 is “no”, an inquiry is made in step 118 as to whether a fixed reference value is present. If the answer is “yes”, the method passes to step 111. If this question is answered in the negative, the method passes to step 109.

If the question in step 116 was answered in the negative, the method passes to step 118 for a different power generation unit, for which the event has not yet occurred, which is indicated by block 119, and it is asked for this power generation unit whether a fixed reference value is present.

The adjustment of the frequency and/or phase of the individual power generation units is accordingly carried out solely by the system control, without the intervention of an operator being required. If a power generation unit is replaced, the phase position of the output signals of the power generation units is adjusted again for the system, in particular automatically, on the basis of the method according to the invention. The aim thereby is not necessarily to achieve the minimum reflected power, but to achieve equal distribution of the power that is produced to all the power generation units. When this is achieved, the system is in the symmetrical state, that is to say the most robust and most stable working point has been achieved. The risk that a power generation unit will switch off because of unsymmetrical distribution of the reflected power is minimized or even non-existent.

The state in which a symmetrical distribution of the power is present is at the same time also the state in which the smallest reflected power occurs with optimal adjustment (e.g., 50 ohms) to the load.

A number of embodiments of the invention have been described. Nevertheless, it will be understood that various modifications may be made without departing from the spirit and scope of the invention. Accordingly, other embodiments are within the scope of the following claims.

What is claimed is:

1. A method performed by a high frequency (HF) power supply system, the method comprising:
performing phase balancing of a first HF power generation unit of a plurality of HF power generation units of the HF power supply system, including:
measuring a first signal that is related to a first power reflected at a load and arriving at the first HF power generation unit;
obtaining at least one first value related to the measured first signal of the first HF power generation unit in a system control;
adjusting at least one of a frequency or a phase of an output signal of the first HF power generation unit based on the at least one first value and a reference value;
measuring a second signal that is related to a second power reflected at the load and arriving at the first HF power generation unit;
obtaining at least one second value related to the measured second signal of the first HF power generation unit in the system control; and
determining whether a specified event for the first HF power generation unit occurs; and
performing phase balancing of one or more further HF power generation units of the HF power supply system.

2. The method of claim 1, further comprising:
monitoring the powers reflected by the load and arriving at each of the HF power generation units; and
determining a relationship between the powers.

3. The method of claim 2, wherein determining whether a specified event occurs comprises determining whether a specified relationship is determined.

4. The method of claim 1, wherein determining whether a specified event occurs comprises determining whether the powers reflected by the load and arriving at each of the HF power generation units differ from one another by less than a predetermined value.

5. The method of claim 1, wherein determining whether a specified event occurs comprises determining at least one of:
whether the second value differs from the reference value by less than a specified amount,
whether the second value has exceeded or fallen short of the reference value,
whether the second value changes in a specified direction,
whether a difference between the second value and the reference value falls short of a specified difference value after repeating a specified number of the adjusting, the measuring of the second signal, and the obtaining of the second value,
whether a particular number of repetitions of the adjusting, the measuring of the second signal, and the obtaining of the second value has been carried out, or
whether a mathematical combination of a plurality of second values, obtained in a number of repetitions of the adjusting, the measuring of the second signal, and the obtaining of the second value, differs from a specified reference value by less than a specified amount, has exceeded or being fallen short of a specified reference value, or changes in a specified direction.

6. The method of claim 1, wherein obtaining at least one first value related to the measured first signal of the HF power generation unit in a system control comprises:
processing the measured first signal to calculate the at least one first value in the HF power generation unit; and
transmitting the calculated at least one first value related to the measured first signal to the system control.

7. The method of claim 1, wherein obtaining at least one first value related to the measured first signal of the HF power generation unit in a system control comprises:
transmitting the measured first signal to the system control; and
calculating the at least one first value related to the measured first signal in the system control.

8. The method of claim 1, further comprising one of:
determining the reference value for the at least one first value of the HF power generation unit in the system control, or
providing the reference value to the system control.

9. The method of claim 1, further comprising determining the reference value based on a mean of the first value and the second value.

10. The method of claim 1, wherein adjusting at least one of a frequency or a phase of an output signal of the HF power generation unit comprises providing a frequency signal and phase information to the HF power generation unit.

11. The method of claim 1, wherein adjusting a phase of an output signal of the HF power generation unit comprises adjusting the phase of the output signal in the HF power generation unit.

12. The method of claim 1, further comprising combining output powers of the HF power generation units to a total power by one or more combiners.

13. The method of claim 1, further comprising adjusting a respective phase of a respective output signal in each of the HF power generation units by a dynamically programmable logic unit.

14. The method of claim 1, further comprising, when the HF power supply system is switched on, determining that at least one HF power generation unit or at least one combiner of the HF power supply system has been replaced or added, and in response:
performing phase balancing of one or more HF power generation units of the HF power supply system.

15. A high frequency (HF) power supply system comprising:
a system control; and
a plurality of HF power generation units,
wherein the HF power generation units are connected in terms of signalling to the system control,
wherein at least two HF power generation units each have a measuring device for detecting a respective signal related to a power reflected at a load and arriving at the respective HF power generation unit,
wherein the HF power supply system has at least one value-calculating unit for calculating values that are related to the respective signals detected by the measuring devices, and
wherein the system control has a calculating device, connected to the HF power generation units, for calculating at least one of a phase or a frequency of an output signal of each of the at least two HF power generation units based on the values calculated in the at least one value-calculating unit.

16. The HF power supply system of claim 15, wherein at least two HF power generation units each have a respective phase-adjusting device, and the respective phase-adjusting devices are connected in terms of signalling to the system control.

17. The HF power supply system of claim 16, wherein each respective phase-adjusting device includes a dynamically programmable logic unit.

18. The HF power supply system of claim 15, wherein the system control includes an evaluation device for evaluating the values that are related to the respective signals detected by the measuring devices.

19. The HF power supply system of claim 15, wherein the system control is provided externally to the plurality of HF power generation units.

20. The HF power supply system of claim 15, further comprising at least one combiner for combining output powers of at least two HF power generation units of the plurality of HF power generation units to a total power.
